(19) United States
(12) Patent Application Publication
(10) Pub. No.: US 2007/0231107 A1
(43) Pub. Date: Oct. 4, 2007

(54) Booklet Making a Machine

(76) Inventor: Karl Nolte, Huddinge (SE)

Correspondence Address: LADAS & PARRY, 26 WEST 61ST STREET, NEW YORK, NY, 10023, US

(21) Appl. No.: 11/587,519

(22) PCT Filed: May 9, 2005
(86) PCT No.: PCT/SE05/00665

§ 371 Date: Oct. 24, 2006

(30) Foreign Application Priority Data
May 17, 2004 (SE) 0401264-7

(51) Int. Cl. B42C 3/00; B42B 5/00

(52) U.S. Cl. 412/33; 412/9

(57) ABSTRACT

A booklet making machine comprises a pair of motor driven rollers (14), between which sheets forming a booklet, after being stapled together, are intended to be entered for folding and feeding for delivery. Each roller comprises a rigid jacket (20) which is attached to a rotation shaft extending in the longitudinal direction of the roller by elastic means (24) disposed between the jacket and the rotation shaft for relative displacement of shaft and jacket in radial direction while overcoming a spring force.

The present invention relates to a booklet making machine comprising a motor driven pair of rollers between which sheets forming the booklet, after being stapled together, are intended to be entered for folding and feeding for delivery.

Booklet making machines comprise one or more motor driven pairs of rollers through which sheets, which are intended to form a booklet, are passed during the stapling and folding procedure. The rollers are fixed mounted on rotating shafts extending a long the center line on the rollers, said rotating shafts being spring loaded towards each other in a pair of rollers. The rotating shafts with their rollers in a pair of rollers are movable towards and away from each other, and the rollers can consequently be separated from each other while overcoming a spring force to enable passage and folding of a varying number of sheets to form booklets of different thicknesses. Such a pair of spring-loaded rollers, which are arranged movable towards and away from each other, results in a complicated construction with spring means, resilient chain tensioner for driving chains, etc.

The purpose of the present invention is to provide a booklet making machine with a considerably simplified roller construction.

This purpose is obtained by a booklet making machine of the kind mentioned in the introductory portion with the characterizing features stated in claim 1.

In the booklet making machine according to the invention the rotating shafts of the rollers are thus fixed mounted in the machine while the necessary separation of the rollers for the folding procedure takes place by the jacket of the roller being displaced radially in relation to its rotation shaft while overcoming a spring force. The jacket of the roller is thus movable in radial direction in relation to its rotation shaft such that the rotation shaft becomes displaced relatively to the central line of the roller, when the rollers in a pair of rollers are separated. In this way a considerably simplified construction is obtained.

According to advantageous embodiments of the machine according to the invention the spring means comprise one or more homogenous pieces of elastic plastics or rubber material or of other suitable elastic materials which pieces have a shape adapted to the inner dimension of the jacket and are disposed inside the jacket, said shaft extending through central holes in the pieces and said jacket being attached at its inner side to the outer surfaces of the piece or pieces and the shaft being attached in the elastic piece or pieces inside the central holes.

Color printers are becoming more and more common. The paper which is used in color printers is smooth. To obtain adequate feeding between the rollers it is, however, not possible to increase the pressure between the rollers too much. Marks are then easily formed in the paper, on the one hand, and, on the other, the stapled together sheets are often separated from each other when the stapled together packet of sheets enters between the rollers, i.e. the outer sheet is pulled away from the booklet, since the friction between the sheets is low. To use rubber rollers, which would give a higher friction towards paper, is not suitable since rubber easily absorbs color, which then can be deposited on other places on the booklet or on subsequent booklets. To obtain desired friction between roller and fed sheet the outer surface of the roller jacket is, according to an advantageous embodiment of the machine according to the invention, coated by molybdenum or tungsten carbide.

According to other advantageous embodiments of the machine according to the invention a feeding out and delivering device is provided at the output from the rollers to successively feed out booklets obtained from the rollers in cascade. The feeding out and delivering device comprises preferably a swiveling plate, mounted over the output opening, below which plate booklets are intended to be fed out while rotating the plate, said plate being balanced, rotatably suspended, such that it retains booklets delivered from the rollers below the plate successively in overlapping positions, in cascade for subsequent feeding out of one booklet at a time for each new booklet delivered from the rollers. By this constructions stapled together and folded, ready booklets will be fed out and delivered in an ordered way, suitably in a pile in a collecting device.

According to other advantageous embodiments of the machine according to the invention a stop member is provided to keep the sheets in a correct position for stapling and folding, which stop member is adjustable between preset positions for keeping sheets of different sizes in correct position. Further, the stop member is preferably stepless adjustable around the different positions preset for different sheet sizes. In this way the machine can easily be adjusted for production of booklets of sheets of different sizes, such as A4, A3, etc., and the position for the staples can easily be fineadjusted, such that the staples are positioned exactly on the folding line.

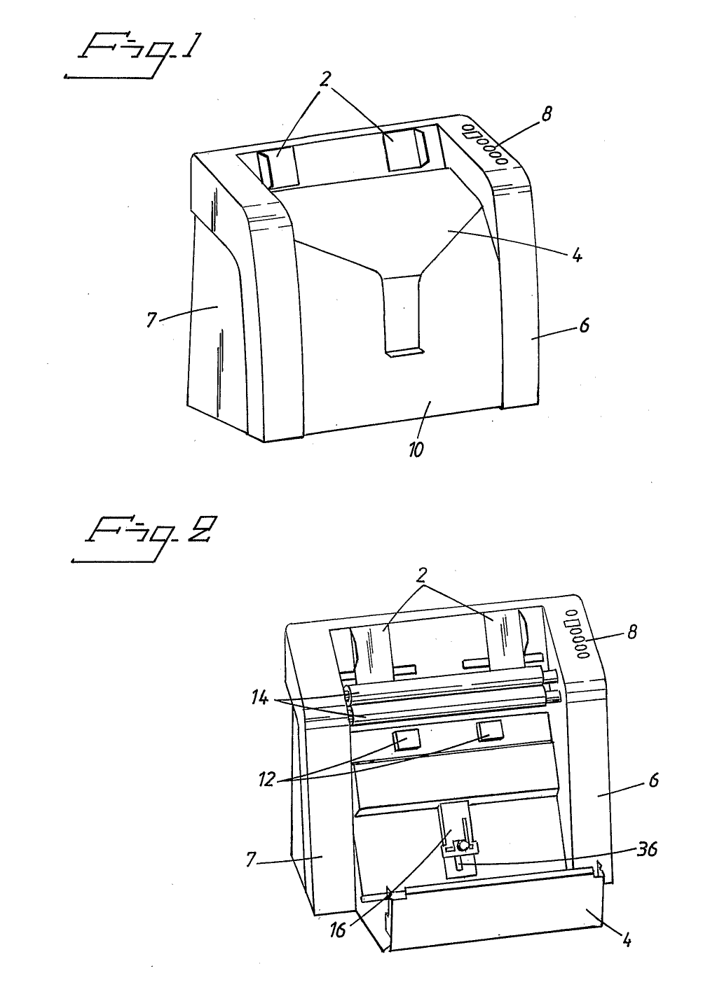

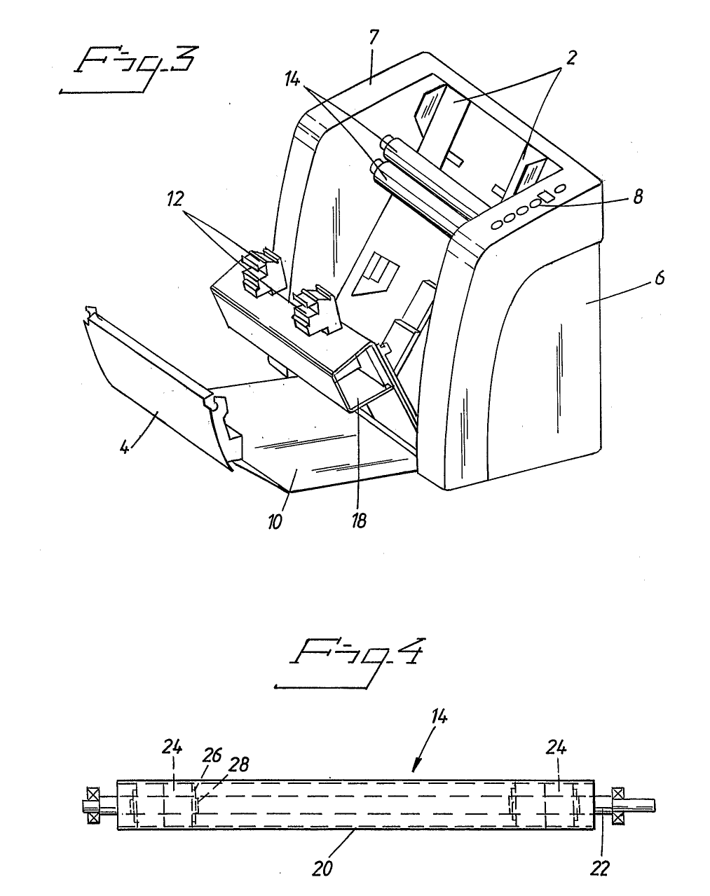

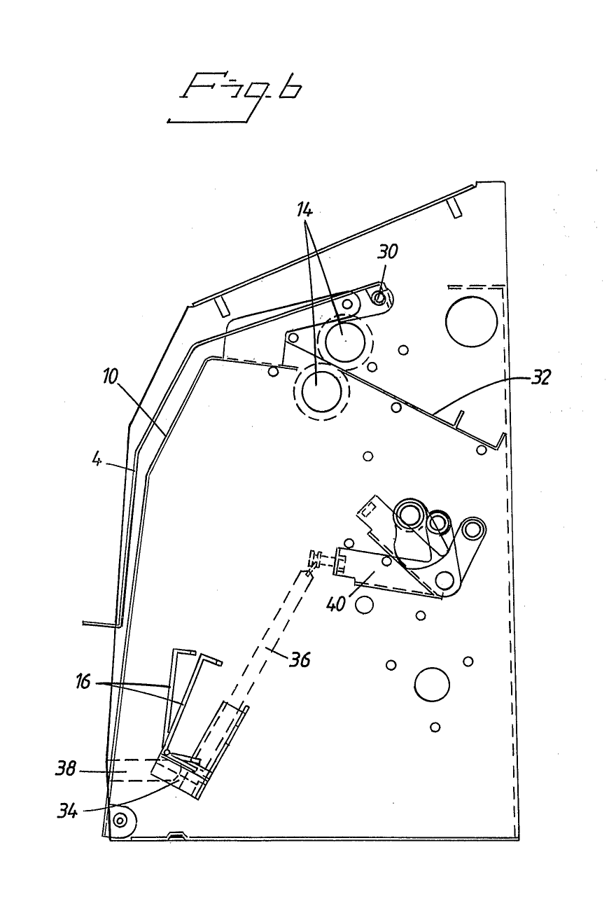

To explain the invention in greater detail an embodiment of the machine according to the invention chosen as an example, will now be described in greater detail with reference to the accompanying drawings, on which FIG. 1 shows the exterior of an embodiment of the machine according to the invention, FIG. 2 shows the embodiment in FIG. 1 with opened front side, FIG. 3 illustrates the general structure of the embodiment according to FIGS. 1 and 2, FIG. 4 shows a longitudinal section of an example of a roller in the machine according to the invention, FIG. 5 shows a cross section of an embodiment of the machine according to the invention, and FIG. 6 shows the cross section in FIG. 5 with certain parts removed.

FIG. 1 shows the exterior of an embodiment of the booklet making machine according to the invention. In the upper part of the machine sheets are fed between the lateral supports 2 for stapling and folding to a booklet. The stapled and folded booklets are fed out below a rotatable plate 4, which will be described in greater detail below. At the upper edge of the side 6 control buttons, indicator lamps and a counting mechanism are provided, at 8, cf. also FIGS. 2 and 3.

The embodiment shown in FIG. 1 is a simple, small machine, intended for stapling together and folding of typically 2-15 sheets to form comparatively thin booklets.

FIG. 2 shows the embodiment in FIG. 1 with opened front side. The front panel 10, see FIGS. 1 and 3, is mounted rotatable around its lower edge and carries the plate 4 disposed over the output opening on the machine, cf. also FIGS. 5 and 6.

In FIG. 2 two staple applying units 12 for stapling together of sheets are shown as well as rollers 14 in a roller pair, between which rollers 14 stapled sheets pass for folding to a booklet. A stop member 16 is provided for keeping fed sheets in correct position for stapling and folding. This stop member 16 is adjustable step-by-step between different preset positions for different sheet sizes and fine-adjustable around the preset positions, as will be described in greater detail below.

FIG. 3 illustrates how the staple applying units 12 are arranged on a mounting plate 18. Also this mounting plate 18 is arranged routable around its lower edge to make machine components placed behind the plate easily accessible. The mounting plate 18 can also be easily lifted out of the machine housing.

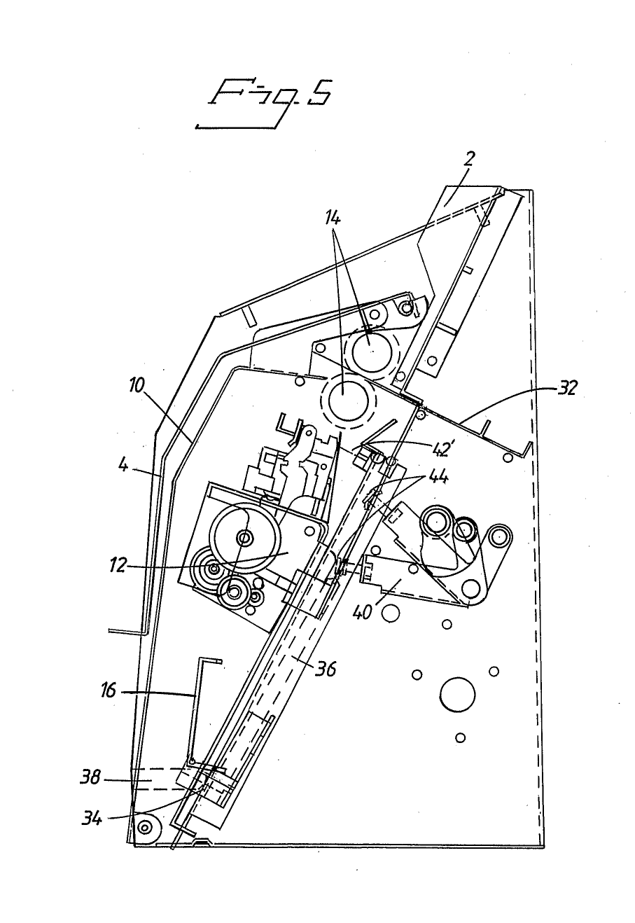

FIG. 4 shows a longitudinal section of an example of a roller 14. The roller 14 comprises a circular cylindrical jacket 20, preferably made of steel. The jacket 20 is mounted on a shaft 22, which is mounted rotatably in bearings in the sidewalls 6, 7 of the machine housing. The shaft 22 is driven by an electric motor in a way which is not further described, as it is not directly related to the invention.

The jacket 20 is resiliently fastened to the shaft 22 by elastic means in the form of two pieces of foam rubber, designed as rolls 24, disposed separated from each other in the longitudinal direction of the shaft 22. Each roll 24 is mounted between a plate of steel 26 and a locking ring, disposed at the end sides of the roller. The diameter of the rolls 24 is adapted to the inner diameter of the jacket 20 and the rolls 24 are fastened to the inner surface of the jacket 20 by their outer surfaces, preferably by gluing. The shaft 22 is extending through a central hole through each of the rolls 24 and the rolls are fastened to the shaft 22, also preferably by gluing. This construction thus makes radial displacement of the roller jacket 20 relatively to the rotation shaft 22 possible while overcoming the spring force from the foam rubber rolls 24.

In operation of the machine the jackets 20 of the rollers 14 in a pair of rollers thus move away from and towards each other while elastically deforming the foam rubber rolls 24 to enable passage of booklets between the rollers while exerting a sufficient pressing force on the booklet to provide efficient folding to make passage of booklets between the rolls 14 possible the jackets are thus separated from each other, such that the shaft 22 will take a non-concentric position in relation to the jackets 20. In the machine according to the invention the rollers are thus arranged on stationarily mounted rotation shafts, required separation of the rollers being provided by radial displacement of the roller jacket relatively to the rotation shaft. This involves important advantages as discussed above.

In FIG. 4 an example is shown with two plastic rolls 24, separated in the direction of the shaft 22. Of course a plurality of other variants is possible. Thus the rotation shaft can be attached to the roller jacket by one single roll of elastic plastics. Such a roller should then have an extension along a major part of the width of the roller. Of course it is also possible to use more than two rolls of plastics, disposed at intervals along the rotation shaft. This could be advantageous in case of long rollers.

In the examples above elastic means in the form of rolls of foamed plastics are described. Of course the jacket can be attached to the shaft by pieces of other elastic plastics or rubber materials or by other suitable elastic material.

As discussed above a correct friction between roller surface and paper is essential, especially when using a smooth paper for color printers. For that reason the outer surface of the jacket 20 is suitably coated by molybdenum or tungsten carbide. A suitable thickness of the coating can be about 85 μm.

In FIGS. 5 and 6 the interior of the machine is shown in a lateral view. FIG. 6 has been simplified by removal of the mounting plate with the staple applying units 12. FIGS. 5 and 6 show how the plate 4 over the output opening is arranged rotatable at its upper part 30. The plate 4 is suspended in a balanced way such that it retains towards the front panel 10 booklets fed out from the rollers 14 successively overlapping, in cascade for subsequent delivery of one booklet at a time for each new booklet, supplied from the rollers 14. In this way an ordered delivery of produced booklets to a suitable collecting device is obtained.

A movable knife 32 is provided to enter the stapled together sheets to the area between the rollers 14 for folding and feeding out, see FIGS. 5 and 6. The knife 32 engages along the folding line of the sheets, along which line the staples are applied.

As mentioned above a stop member 16 is provided for holding the sheets in correct position for the stapling. The stop member 16 is adjustable between two positions, see FIG. 6, to be able to hold sheets of two different sizes, e.g. A3 and A4, in correct positions for stapling. The position of the stop member 16 can be a fineadjusted by moving the fastener 34 of the stop member along a threaded pin 36, see FIG. 2, with the aid of an adjusting screw 38.

The fastener 34 is connected to the end of an arm 40 via the threaded pin 36, which arm by a cam structure is turned to an upper position after the stapling operation. The stop member 16 is then raised, and with the stop member also the sheets resting on the stop member 16 a distance corresponding to distance between the position 42 for stapling and the position for the knife 32, see FIG. 5. In this way the knife will engage along that line on which the staples are applied and this line will form folding line at the folding.

Adjusting means in the form of an adjusting screw 44, accessible from the front side of the machine is provided for fineadjustment, when needed, of the position of the staple applying units relatively to the sheets, such that the staples will be positioned exactly along the folding line and consequently in the back of the produced booklet. By turning the screw 44 the angle position of the staple applying units 12 will be somewhat altered, and with that the stapling position relatively to the sheets.

1. Booklet making machine comprising a pair of motor driven rollers between which sheets forming a booklet, after being stapled together, are intended to be entered for folding and feeding for delivery, characterized in that each roller comprises a rigid jacket which is attached to a rotation shaft extending in the longitudinal direction of the roller by elastic means arranged between the jacket and the rotation shaft for relative displacement of shaft and jacket in radial direction while overcoming a spring force.

2. Machine according to claim 1 , characterized in that said elastic means comprises at least one circular cylindric homogeneous piece of elastic plastics or rubber material or of other suitable elastic material, which piece is adapted to the inner dimension of the jacket and is positioned inside the jacket, through which piece the shaft is extending in a central hole, said jacket being attached at its inner side to the outer side of said piece and said shaft is fastened in the elastic piece inside said central hole.

3. Machine according to claim 2, characterized in that a plurality of said elastic pieces is disposed inside the jacket with intervals in the longitudinal direction of the jacket.

4. Machine according to claim 1, characterized in that the outer surface of the jacket is coated by molybdenum or tungsten carbide to give desired friction against sheets fed between the rollers.

5. Machine according to claim 1, characterized in that a knife displaceable relatively to the rollers is provided for entering stapled together sheets in the area between the rollers for folding and feeding between the rollers.

6. Machine according to claim 1, characterized in that a feeding out and delivery device is provided at the output from the rollers for successively feeding out, in cascade, booklets obtained from the rollers.

7. Machine according to claim 6, characterized in that said feeding out and delivery device comprises a rotatable plate, disposed over the output opening, below which plate booklets are intended to be fed out while rotating the plate, said plate being balanced, rotatably suspended, such that the plate retains booklets delivered from the rollers below the plate successively overlapping in cascade for subsequent feeding out of one booklet at a time for each new booklet delivered from the rollers.

8. Machine according to claim 1, characterized in that a stop member is provided to keep said sheets in a correct position for stapling and folding, said stop member being adjustable between preset positions to keep sheets of different sizes in correct position.

9. Machine according to claim 8, characterized in that said stop member is stepless adjustable around the preset positions for different sheet sizes.

10. Machine according to claim 1, characterized in that adjusting means are provided for adjusting the position of staple applying units relatively to the sheets for adjusting the position of the applied staples on the sheets.
